(19) United States
(12) Patent Application Publication
(10) Pub. No.: US 2012/0177425 A1
(43) Pub. Date: Jul. 12, 2012

(54) GLOSSY SURFACE FORMING APPARATUS AND GLOSSY SURFACE FORMING METHOD

(75) Inventors: Aya SHIRAI, Tokyo (JP); Tatsuya NAGASE, Tokyo (JP); Asao MATSUSHIMA, Tokyo (JP); Yasuko UCHINO, Tokyo (JP); Ryuichi HIRAMOTO, Tokyo (JP); Michiyo FUJITA, Tokyo (JP)

(73) Assignee: KONICA MINOLTA BUSINESS TECHNOLOGIES, INC., Tokyo (JP)

(21) Appl. No.: 13/338,799

(22) Filed: Dec. 28, 2011

(30) Foreign Application Priority Data
Jan. 11, 2011 (JP) JP2011-002787

(51) Int. Cl. G03G 15/20

(52) U.S. Cl. 399/341

(57) ABSTRACT

Disclosed is a glossy surface forming apparatus containing a heating member to heat an image support on which a toner has been supplied, a belt member with which the image support is brought into close contact via the toner having been melted via heating by the heating member to convey the image support in a state of being in close contact, a cooling member to cool the toner on the image support which is being conveyed in a state of being in close contact with the belt member, and a separating member to separate the image support on which the toner has been solidified via cooling by the cooling member from the belt member, and the belt member contains at least a polyimide resin having a fluorine atom in the molecular structure and the center line average roughness Ra of the surface making contact with a toner layer is at most 0.3 μm. A glossy surface forming method is also disclosed.

This application is based on Japanese Patent Application No. 2011-002787 filed on Jan. 11, 2011, in Japanese Patent Office, the entire content of which is hereby incorporated by reference.

### TECHNICAL FIELD

The present invention relates to a glossy surface forming apparatus and a glossy surface forming method to form a glossy surface on an image support using a toner.

### BACKGROUND

Over recent years, with advance of digital technology in addition to the conventional silver halide photographic system and the printing system such as gravure printing, print images represented by photographic images and posters have been also able to be produced using ink-jet apparatuses or electrophotographic image forming apparatuses. Of photographic images and posters produced using such image forming apparatuses, there are those in which a glossy surface is formed on an image support.

As the technique to form a glossy surface on an image support, for example, a method employing a colorless toner containing no colorant component referred to as a clear toner or a transparent toner is cited as a typical method. In this method, for example, on a substrate on which an image has been formed using a toner or ink, a clear toner is fed to form a clear toner layer and then the image support on which the clear toner layer has been formed is heated to form a glossy surface. Such a method makes it possible to eliminate the gloss difference between the area of an image formed using a colored toner or ink and the area without the image (a portion in which the image support is exposed) to obtain uniform glossy feeling. Especially when a clear toner is fed over the entire image support, more uniform glossy feeling is realized. Further, even when a clear toner is fed to an area such as a white background other than the area of an image having been formed using a colored toner, uniform glossy feeling is achieved.

One of the methods to form a uniform glossy surface on an image support using a toner containing a clear toner as described above is a method to carry out glossy surface formation using an apparatus referred to as a glossy surface forming apparatus. In this method, for example, an apparatus of the embodiment shown in FIG. 2 to be described later is used in which an image support on which a toner has been fed is heated to melt the toner, and then via a melted toner, the image support is brought into close contact with a belt member. Then, in the state of being in close contact with the belt member, the image support is cooled to solidify the toner, and thereafter a solidified toner is separated from the belt member to form a glossy surface on the image support (for example, refer to Patent Document 1).

In the glossy surface forming apparatus of the embodiment shown in FIG. 2, via a melted toner, an image support is brought into close contact with a belt member to form a glossy surface. Since the belt member constituting the apparatus makes contact with a heating roller, heat resistance has been required. In a belt member required to exhibit heat resistance, a metallic material or a heat resistant resin represented by a polyimide resin is being used as a base body. Further, a belt member to form a glossy surface has been required to exhibit surface smoothness so as to form a smooth glossy surface after solidification of a toner layer having been brought into close contact with the belt member and further releasability to smoothly separate a solidified toner layer.

As a technique to provide such a belt member with heat resistance and releasability with respect to a toner, a technique pertaining to a polyimide resin-made belt member having a releasing layer used as a belt member for a fixing deice is disclosed (for example, refer to Patent Document 2). For example, in above Patent Document 2, there is disclosed a belt member in which on a polyimide film base body, an intermediate layer employing a rubber elastic body and a releasable surface layer incorporating a fluorine resin are provided.

### PRIOR ART DOCUMENTS

Patent Documents
Patent Document 1: Unexamined Japanese Patent Application Publication No. 2002-341619
Patent Document 2: Unexamined Japanese Patent Application Publication No. H10-111613

### BRIEF DESCRIPTION OF THE INVENTION

### Problems to be Solved by the Invention

In Patent Document 2 described above, a disclosed belt member was reviewed in use for a fixing belt but any description such that applications to the belt member for a glossy surface fanning apparatus was suggested was not made. Thus, the present inventors attempted to use the belt member disclosed in Patent Document 2 for a glossy surface forming apparatus and found, however, that the following problems were produced.

Namely, it was found that when glossy surface formation was carded out using the belt member of Patent Document 2, with continuous use, a releasable surface layer containing a fluorine resin was worn away and then a rubber elastic layer below this layer was exposed, whereby no releasability was expressed, resulting in an decrease in image gloss.

Further, in the glossy surface forming apparatus, the surface smoothness of the belt member is provided on the toner layer surface and thereby the toner layer surface is allowed to be smooth to provide gloss. Therefore, the belt member for glossy surface formation is required to exhibit enhanced smoothness. However, Patent Document 2 did not describe the surface roughness of the belt member and thereby there was no suggestion on the production of a belt member exhibiting enhanced smoothness.

In view of the above problems, the present invention was completed and an object thereof is to provide a glossy surface forming apparatus and a glossy surface forming method capable of continuously forming a glossy surface having enhanced glossiness using a toner, as well as a belt member for glossy surface formation.

### Means to Solve the Problems

The present inventors found that the above problems were solved by any of the constitutions described below.

In a glossy surface forming apparatus provided with at least a heating member to heat an image support on which a toner has been fed, a belt member with which the image support is brought into close contact via the toner having been melted via heating by the heating member to convey the image support in the state of being in close contact, a cooling member to cool the toner on the image support which is being conveyed in the state of being in close contact with the belt member, and a separating member to separate the image support on which the toner has been solidified via cooling by the cooling member from the belt member, a glossy surface forming apparatus in which the belt member contains at least a polyimide resin having a fluorine atom in the molecular structure and the center line average roughness Ra of the surface making contact with a toner layer is at most 0.3 μm.

The separating member preferably separates the image support from the belt member at the position to change the conveyance direction of the belt member.

A glossy surface forming apparatus, described in claim 1 or 2, in which a polyimide resin having a fluorine atom in the molecular structure contained in a belt member is formed in such a manner that a carboxylic acid dianhydride represented by following Formula (1) and a diamine represented by following Formula (2) are allowed to react together to produce a polyimide precursor, which is then imidized.

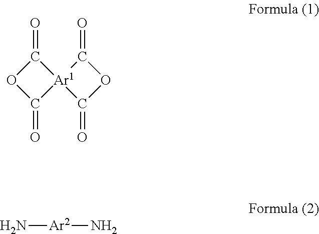

wherein Ar¹ in Formula (1) represents a tetravalent organic group; Ar² in Formula (2) represents a divalent organic group; and at least either of the organic groups Ar¹ and Ar² contains an organic group having a fluorine atom in the molecular structure.

The toner is preferably a clear toner.

A glossy surface forming method comprising steps of;

supplying a toner onto an image support,

bringing a side having the toner of the image support into close contact with a belt member,

heating and pressing the image support making close contact with a belt member to melt the toner,

cooling the image support having the toner having been melted in the above step in a state of being in close contact with the belt member, and

separating the image support on which the toner has been solidified by cooling from the belt member,

wherein the belt member contains at least a polyimide resin having a fluorine atom in a molecular structure and center line average roughness Ra of a surface making contact with a toner layer is at most 0.3 μm.

In the step to separate an image support from the belt member, at the position to change the conveyance direction of the belt member, the image support is preferably separated from the belt member.

A polyimide resin having a fluorine atom in the molecular structure contained in a belt member is formed in such a manner that a carboxylic acid dianhydride represented by following Formula (1) and a diamine represented by following Formula (2) are allowed to react together to produce a polyimide precursor which is then imidized.

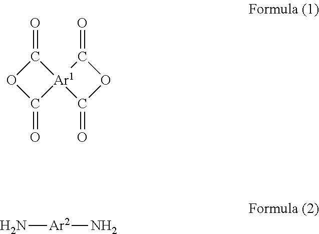

wherein Ar¹ in Formula (1) represents a tetravalent organic group; Ar² in Formula (2) represents a divalent organic group; and at least either of the organic groups Ar¹ and Ar² contains an organic group having a fluorine atom in the molecular structure.

The toner is preferably a clear toner.

According to the present invention, a glossy surface forming apparatus and a glossy surface forming method employing a belt member in which a polyimide resin having a fluorine atom in the molecular structure was incorporated and the center line average roughness Ra of a surface making contact with a toner layer was at most 03 μm made it possible to continuously form a glossy surface exhibiting enhanced glossiness. Specifically, using a belt member exhibiting smoothness in which the center line average roughness Ra of a surface making contact with a toner layer is at most 0.3 μm, a glossy surface is produced and thereby there can be formed a glossy surface having a glossiness of at least 70, which is obtained via determination based on, for example, “JIS 28741 1983 method 2” at a measurement angle of 20°.

Further, since the belt member exhibiting smoothness is formed of a polyimide resin having a fluorine atom in the molecular structure, a releasable surface layer containing a fluorine resin needs not to be provided separately. Still further, even in the case where the belt is worn away with continuous use, since a fluorine atom is contained in the belt member, releasability can be continuously expressed with no change even when worn away. Thereby, a glossy surface exhibiting enhanced glossiness can be formed stably and continuously.

### BRIEF DESCRIPTION OF THE DRAWINGS

FIG. 1 is a schematic view showing the structure of a belt member used in the present invention;

FIG. 2 is a chart illustrating center line average roughness;

FIG. 3 is a schematic view of a glossy surface forming apparatus in which a toner having been fed on an image support is melted and a melted toner is cooled to form a glossy surface on the image support; and

FIG. 4 is a schematic view of an image forming apparatus incorporating the glossy surface forming apparatus of FIG. 3.

### PREFERRED EMBODIMENT OF THE INVENTION

The present invention relates to a glossy surface forming apparatus and a glossy surface forming method in which a toner layer having been fed on an image support is heated and via a melted toner layer, the image support is cooled in the state of being close contact with a belt member to form a glossy surface. Further, a belt member used to form a glossy surface in the present invention contains a polyimide resin having a fluorine atom in the molecular structure and the center line average roughness Ra of a surface making contact with a toner layer is at most 0.3 μm.

With regard to a glossy surface formed on an image support based on the present invention, there is obtained one having a glossiness of at least 70 when determination is conducted based on, for example, “JIS Z8741 1983 method 2” at a measurement angle of 20°. This fact makes it possible that when the center line average roughness of a surface making contact with a toner layer is allowed to be at most 0.3 μm, the belt member surface is provided with enhanced smoothness to form a glossy surface having the above glossiness.

Further, a fluorine atom present in a polyimide resin molecule provides the belt member surface with appropriate releasability. In this manner, in the case where a belt member is fanned of a polyimide resin containing a fluorine atom in the molecular structure, even when the belt member is worn away due to the contact with an image support during continuous glossy surface formation, releasability can be expressed with no change. Therefore, even when glossy surface formation is continuously carried out, no gloss decrease problem will occur.

The present invention will now be detailed.

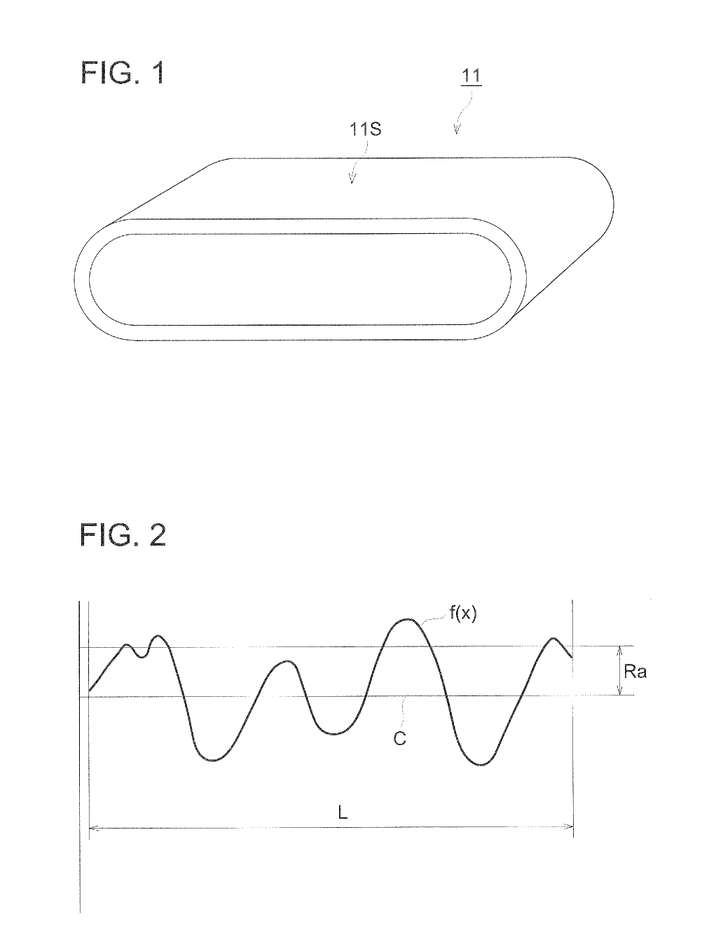

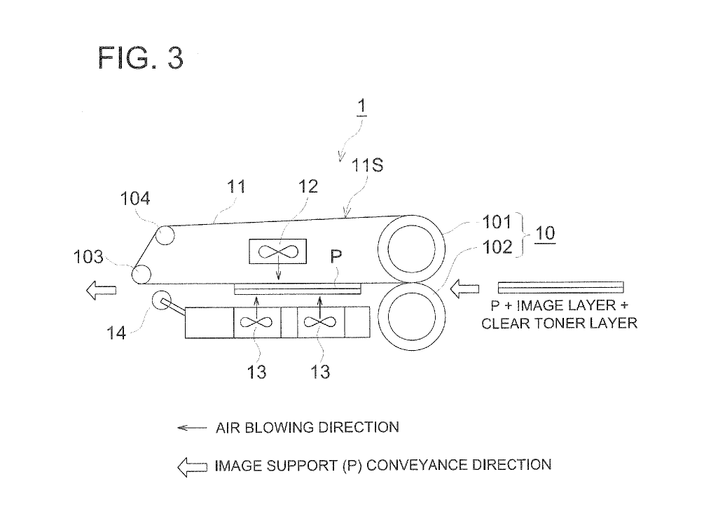

Initially, a belt member used in the present invention will be described. A belt member used in the present invention can be used in a glossy surface forming apparatus as shown in FIG. 2 to be described later, the belt member having an endless shape as shown by symbol 11 in FIG. 3. FIG. 1 schematically shows a belt member 11 usable in the present invention. The portion shown by symbol 11S of the belt member 11 is a portion to serve as a surface making contact with a toner layer when the belt member is mounted in the glossy surface forming apparatus 1. The belt member 11 contains, as described above, “at least a polyimide resin having a fluorine atom in the molecular structure” and also has “a center line average roughness Ra of at most 0.3 μm with respect to a surface making contact with a toner layer.”

A polyimide resin containing a fluorine atom in the molecular structure used in the present invention will now be described. Polyimide is generally formed by condensation reaction of an aromatic polycarboxylic acid anhydride or its derivative and an aromatic diamine as shown in the following formulas.

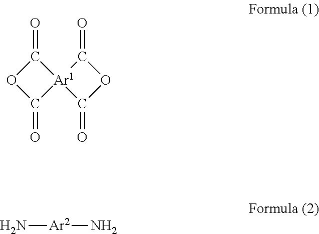

wherein Ar¹ in Formula (1) represents a tetravalent organic group; Ar² in Formula (2) represents a divalent organic group. When a polyimide resin used in the present invention is formed, at least either of the organic groups Ar¹ and Ar² in the above formulas has an organic group having a fluorine atom represented by a trifluoromethyl group —CH₃. Herein, the “organic group” refers to a hydrocarbon group such as an alkyl group, a vinyl group, or an aryl group. Ar¹ in Formula (1) and Ar2 in Formula (2) are preferably an aryl group, and as the organic group having a fluorine atom, an alkyl group is preferable.

A reaction formula to form a polyimide by condensation reaction of an aromatic polycarboxylic acid anhydride and an aromatic diamine is shown below.

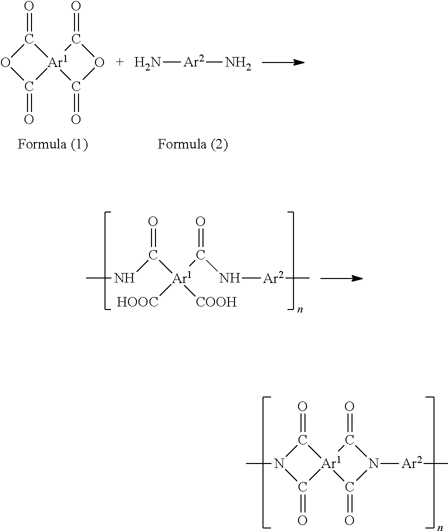

The above reaction formula is concerned with a method referred to as a 2-stage method which is one of the common polyimide synthetic methods industrially used. In such a 2-stage method, initially, an aromatic polycarboxylic acid dianhydride represented by Formula (1) and an aromatic diamine represented by Formula (2) are polymerized together at an equimolar amount to produce a polyamide acid (polyamic acid) serving as a polyimide precursor. Molecular weight of the polyimide precursor is preferably weight average molecular weight of 20,000 to 100,000.

Subsequently, the thus-produced polyimide precursor is subjected to dehydration reaction by heating at a temperature of at least 200° C. or using a catalyst for advancement of cyclization reaction referred to as imidization to produce a polyimide.

Most polyimides produced via the above reaction formula are dissolved in an organic solvent in the case of polyamide acid structures, but not dissolved therein in the case of polyimides. Therefore, when a surface layer is formed in the present invention, by use of a polyamide acid solution, the solution is subjected to imidization and thereby a surface layer containing a polyimide resin can be formed.

Further, the synthetic method of a polyimide includes, in addition to the above 2-stage method, a method referred to as a single stage method in which an aromatic polycarboxylic acid anhydride or its derivative and an aromatic diisocyanate are allowed to react together to produce a polyimide.

A polyimide resin formed using a carboxylic acid dianhydride represented by Formula (1) and a diamine represented by Formula (2) contains an alkyl group having a fluorine atom in at least either of organic groups Ar¹ and Ar² becoming polyimide repeating units. In this manner, when an alkyl group having a fluorine atom is contained in a polyimide molecule, releasability can be expressed with maintenance of excellent mechanical characteristics of a polyimide resin. Therefore, in the present invention, for a belt member, a polyimide resin containing a fluorine atom is employed and thereby, even an image support having been in contact with the belt member via a melted toner can be smoothly separated by the action of an external force generated by the conveyance direction change of the belt member.

To incorporate an alkyl group having a fluorine atom into an organic group Ar¹ or Ar² becoming a polyimide repeating unit, an alkyl group having a fluorine atom needs to be incorporated in an organic group Ar¹ in a carboxylic acid dianhydride or an organic group Ar² in a diamine serving as a raw material. An alkyl group having a fluorine atom can be introduced into such an organic group Ar² in a carboxylic acid dianhydride or an organic group Ar² in a diamine via substitution reaction performed with respect to aromatic compounds.

Further, as organic groups having a fluorine atom, those in which an alkyl group is bonded to a fluorine atom are typically cited. In such organic groups having a fluorine atom, those with a larger number of bonded fluorine atoms tend to resemble a fluorine resin structure and thereby enhanced releasability is expected. Still further, the number of carbon atoms constituting an alkyl group is not specifically limited either, but those with a smaller number of carbon atoms are advantageous due to structural compactness, since introduction into the above organic group Ar¹ or Ar² is readily carried out From such a point of view, of the alkyl groups containing a fluorine atom, a trifluoromethyl group —CH₃ is preferable. Specific examples of an alkyl group of a carbon atom number of 1-3 having a fluorine atom are listed below. However, the alkyl group having a fluorine atom employable in the present invention is not limited thereto.

| | | |
|---|---|---|
| —CH₂F | —CHF₂ | CF₃ |
| —CHFCH₂F | —CHFCHF₂ | —CF₂CHF₂ |
| —CH₂CHF₂ | —CHFCF₃ | —CF₂CF₃ |
| —CHFCHFCH₂F | —CHFCHFCHF₂ | —CHFCHFCF₃ |
| —CH₂CF₂CF₃ | —CHFCF₂CF₃ | —CF₂CF₂CF₃ |

Next, specific examples of an organic group Ar¹ constituting the carboxylic acid dianhydride represented by Formula (1) having a fluorine atom in the molecular structure will be listed. Herein, most of the following specific examples are those containing a trifluoromethyl group as an alkyl group having a fluorine atom but the alkyl group having a fluorine atom bonded to the carboxylic acid dianhydride represented by Formula (1) usable in the present invention is not limited to the following.

There are listed (trifluoromethyl)pyromellitic acid, bis(trifluoromethyl)pyromellitic acid, 5,5′-bis(trifluoromethyl)-3,3′,4,4′-tetracarboxybiphenyl, 2,2′,5,5′-tetrakis(trifluoromethyl)-3,3′,4,4′-tetracarboxybiphenyl, 5,5′-bis(trifluoromethyl)-3,3′,4,4′-tetracarboxydiphenyl ether, 5,5′-bis(trifluoromethyl)-3,3′,4,4′-tetracarboxybenzophenone, bis[(trifluoromethyl)dicarboxyphenoxy]benzene, bis[(trifluoromethyl)dicarboxyphenoxy]biphenyl, bis[(trifluoromethyl)dicarboxyphenoxy](fluoromethyl)benzene, bis[(trifluoromethyl)dicarboxyphenoxy)bis(trifluoromethyl)biphenyl, bis[(trifluoromethyl)dicarboxyphenoxy)diphenyl ether, bis(dicarboxyphenoxy)(trifluoromethyl)benzene, bis(dicarboxyphenoxy)bis(trifluoromethyl)benzene, bis(dicarboxyphenoxy)tetrakis(trifluoromethyl)benzene, bis(dicarboxyphenoxy)bis(trifluoromethyl)biphenyl, bis(dicarboxyphenoxy)tetrakis(trifluoromethyl)biphenyl, 2,2-bis(3,4-dicarboxyphenyl)hexafluoropropane, and 2,2′-bis[4-(3,4-dicarboxyphenoxy)phenyl]hexafluoropropane.

Next, specific examples of an organic group Ar² constituting the diamine represented by Formula (2) having a fluorine atom in the molecular structure will be listed. Herein, most of the following specific examples are those containing a trifluoromethyl group as an alkyl group having a fluorine atom but the alkyl group having a fluorine atom bonded to the diamine represented by Formula (2) usable in the present invention is not limited to the following.

There are listed diaminobenzotrifluoride, bis(trifluoromethyl)phenylenediamine, diaminotetra(trifluoromethyl)benzene, diamino(pentafluoroethyl)benzene, 2,2′-bis(trifluoromethyl)benzidine, 3,3′-bis(trifluoromethyl)benzidine, 2,2′-bis(trifluoromethyl)-4,4′-diaminodiphenyl ether, 3,3′-bis(trifluoromethyl)-4,4′-diaminodiphenyl ether, 3,3′,5,5′-tetrakis(trifluoromethyl)-4,4′-diaminodiphenyl ether, 3,3′-bis(trifluoromethyl)-4,4′-diaminobenzophenone, bis(aminophenoxy)di(trifluoromethyl)benzene, bis(aminophenoxy)tetrakis(trifluoromethyl)benzene, bis[(trifluoromethyl)aminophenoxy]benzene, bis[(trifluoromethyl)aminophenoxy]biphenyl, bis{[(trifluoromethyl)aminophenoxy]phenyl}hexafluoropropane, 2,2′-bis(trifluoromethyl)-4,4′-diaminobiphenyl, 2,2′-bis[4-(p-aminophenoxy)phenyl]hexafluoropropane, 2,2′-bis[4-(m-aminophenoxy)phenyl]hexafluoropropane, 2,2′-bis[4-(o-aminophenoxy)phenyl]hexafluoropropane, 2-[4-(p-aminophenoxy)phenyl]2-[4-(m-aminophenoxy)phenyl]hexafluoropropane, 2-[4-(m-aminophenoxy)phenyl]-2-[4-(o-aminophenoxy)phenyl]hexafluoropropane, and 2-[4-(o-aminophenoxy)phenyl]-2-[4-(p-aminophenoxy)phenyl]hexafluoropropane.

In the polyimide resin incorporated in a belt member used in the present invention, as described above, at least a carboxylic acid dianhydride or its derivative and a diamine having a fluorine atom in the molecular structure are used as raw materials. However, formation by combination of a carboxylic acid dianhydride or its derivative and a diamine having no fluorine atom is employable.

As a typical example of such a carboxylic acid dianhydride having no fluorine atom, tetracarboxylic acid dianhydride is cited and then the following exemplified compounds are listed.

Namely, there are listed pyromellitic acid dianhydride, 3,3′,4,4′-benzophenonetetracarboxylic acid dianhydride, 2,2′,3,3′-benzophenonetetracarboxylic acid dianhydride, 3,3′,4,4-biphenyltetracarboxylic acid dianhydride, 2,2′,3,3′-biphenyltetracarboxylic acid dianhydride, 2,2′-bis(2,3-dicarboxyphenyl)propane dianhydride, bis-(3,4-dicarboxyphenyl)ether dianhydride, 1,1-bis(3,4-dicarboxyphenyl)sulfone dianhydride, 1,1-bis(2,3-dicarboxyphenyl)ethane dianhydride, bis(2,3-dicarboxyphenyl)methane dianhydride, bis(3,4-dicarboxyphenyl)methane dianhydride, 2,2-bis(3,4-dicarboxylphenyl)-1,1,1,3,3,3-hexafluoropropane dianhydride, 2,3,6,7-naphtharenetetracarboxylic acid dianhydride, 1,4,5,8-naphtharenetetracarboxylic acid dianhydride, 1,2,5,6-naphtharenetetracarboxylic acid dianhydride, 1,2,3,4-benzenetetracarboxlylic acid dianhydride, 3,4,9,10-perylenetetracarboxylic acid dianhydride, 2,3,6,7-anthracenetetracarboxylic acid dianhydride, and 1,2,7,8-phenanethrenetetracarboxylic acid dianhydride. These can be used alone or in combination of 2 types or more.

Further, as exemplified compounds of the diamine having no fluorine atom usable in combination, the following is cited.

Namely, there are listed m-phenylenediamine, o-phenylenediamine, p-phenylenediamine, m-aminobenzylamine, p-aminobenzylamine, 4,4′-diaminophenyl ether, 3,3′-diaminophenyl ether, 3,4-diaminodiphenyl ether, bis(3-aminophenyl)sulfide, (3-aminophenyl)(4-aminophenyl)sulfide, bis(4-aminophenyl)sulfide, bis(3-aminophenyl)sulfoxide, (3-aminophenyl)(4-aminophenyl)sulfoxide, bis(3-aminophenyl)sulfone, (3-aminophenyl)(4-aminophenyl)sulfone, bis(4-aminophenyl)sulfone, 3,3′-diaminobenzophenone, 3,4′-diaminobenzophenone, 4,4′-diaminobenzophenone, 3,3′-diaminophenylmethane, 3,4′-diaminophenylmethane, 4,4′-diaminophenylmethane, bis[4-(3-aminophenoxy)phenyl]methane, bis[4-(4-aminophenoxy)phenyl]methane, 1,1-bis[4-(3-aminophenoxy)phenyl]ethane, 1,1-bis[4-(4-aminophenoxy)phenyl]ethane, 1,2-bis[4-(3-aminophenoxy)phenyl]ethane, 1,2-bis[4-(3-aminophenoxy)phenyl]ethane, 1,2-bis[4-(4-aminophenoxy)phenyl]ethane, 2,2-bis[4-(3-aminophenoxy)phenyl]propane, 2,2-bis[4-(4-aminophenoxy)phenyl]propane, 2,2-bis[4-(3-aminophenoxy)phenyl]butane, 2,2-bis[3-(3-aminophenoxy)phenyl]-1,1,1,3,3,3-hexafluoropropane, 2,2-bis[4-(4-aminophenoxy)phenyl]-1,1,1,3,3,3-hexafluoropropane, 1,3-bis(3-aminophenoxy)benzene, 1,3-bis(4-aminophenoxy)benzene, 1,4-bis(3-aminophenoxy)benzene, 1,4-bis(4-aminophenoxy)benzene, 4,4-bis(3-aminophenoxy)biphenyl, 4,4′-bis(4-aminophenoxy)biphenyl, bis[4-(3-aminophenoxy)phenyl]ketone, bis[4-(4-aminophenoxy)phenyl]ketone, bis[4-(3-aminophenoxy)phenyl]sulfide, bis[4-(4-aminophenoxy)phenyl]sulfide, bis[4-(3-aminophenoxy)phenyl]sulfoxide, bis[4-(4-aminophenoxy)phenyl]sulfoxide, bis[4-(3-aminophenoxy)phenyl]sulfone, bis[4-(4-aminophenoxy)phenyl]sulfone, bis[4-(3-aminophenoxy)phenyl]ether, bis[4-(4-aminophenoxy)phenyl]ether, 1,4-bis[4-(3-aminophenoxy)benzoyl]benzene, 1,3-bis[4-(3-aminophenoxy)benzoyl]benzene, 4,4′-bis[3-(4-aminophenoxy)benzoyl]diphenyl ether, 4,4′-bis[4-(4-amino-α,α-dimethylbenzyl)phenoxy)]benzophenone, 4,4′-bis[4-(4-amino-α,α-dimethylbenzyl)phenoxy)]diphenyl sulfone, bis[4-[4-(4-aminophenoxy)phenoxy]phenyl]sulfone, 1,4-bis[4-(4-aminophenoxy)phenoxy-α,α-dimethylbenzyl]benzene, and 1,3-bis[4-(4-aminophenoxy)phenoxy-α,α-dimethylbenzyl]benzene. These can be used alone or in combination of 2 types or more.

A polyimide resin containing a fluorine atom incorporated in a belt member 11 used in the present invention can be produced using any of the above compounds. In other words, the above compound including the compounds represented by Formulas (1) and (2) is dissolved in an aprotic polar solvent and then heated with stirring at mom temperature or at 40-80° C. to form a polyamide acid serving as a polyimide resin precursor. Incidentally, specific examples of the aprotic polar solvent include, for example, N-methyl-2-pyrrolidone, dimethylformamide, dimethylacetamide, dimethylsulfoxide, dimethylimidazoline, and hexamethylphosphoramide.

A polyamide acid serving as a polyimide resin precursor is dissolved in a solvent such as an amide-based solvent or polyamic acid as listed below to prepare a solution referred to as a polyimide varnish having a required solid content and exhibiting viscosity, which is then usable. Specific examples of a solvent employable in preparation of such a polyimide varnish include, as the amide-based solvent, for example, N-methylpyrrolidone (NMP), N,N-dimethylformamide (DMF), and N,N-dimethylacetamide (DMAc). Further, for example, γ-butyrolactone is cited as the polyamic acid-based solvent and then also usable are ethyl lactate, methoxymethyl propionate, and propylene glycol monomethyl ether acetate.

In preparation of a polyimide varnish, from the viewpoint of a better balance between the viscosity and handling of the varnish, the added amount of a solvent is preferably 250 parts by mass—2000 parts by mass (about 5-30% by mass in terms of solid content concentration) based on 100 parts by mass of a polyimide precursor. This polyimide varnish is dissolved in a certain organic solvent if appropriate to prepare a film forming liquid. Then, the thus prepared film forming liquid is coated on a base body using a coater. After coating, the resulting product is heated at a predetermined temperature for imidization and thereby a belt member 11 having been produced with a polyimide resin containing a fluorine atom can be formed. The heating temperature during imidization is preferably 100° C.-400° C., more preferably 200° C.-300° C. from the viewpoint of sufficient advancement of imidization.

The control method of the center line average roughness Ra of a surface 11S making contact with a toner layer of a belt member 11 depends on the production method of the belt member 11. Ra can be controlled by selecting a temperature and/or time period in imidization process. Incidentally, the production method of a belt member 11 used in the present invention is not specifically limited and any appropriate common production method is applicable, including, for example, a centrifugal molding method, Now, the centrifugal molding method, which is one of the typical production methods of belt members, will briefly be described.

Initially, into the interior of a rotating cylindrical molding die, a solution of a resin which has been dissolved in a solvent is poured using a spray or nozzle. Then, this molding die is rotated at high speed, and via the action of a centrifugal force generated by rotation, the resin solution is spread to form a uniform film, which is then solidified. In such procedures, an endless (belt-shaped) molded body is produced. This method is advantageous in production of a belt-shaped base body having relatively uniform thickness. In this process, rotation is conducted with centrifugal force of 10 to 20 times and preferably 17 to 17 times of gravity, and for 3 to 10 minutes preferably 4 to 7 minutes.

In this case, the shape of the inner surface of a cylindrical molding die, namely, the shape of a surface making contact with the side brought into contact with a toner layer of a belt member 11 is transferred as the surface of the belt member 11. Therefore, this surface is preferably smooth. For example, when the center line average roughness of the inner surface of the molding die is allowed to be at most 0.3 μm, the center line average roughness Ra of the surface 11S making contact with the toner layer of the belt member 11 can be at most 0.3 μm.

The belt member 11 preferably exhibits thermal conductivity and also flexibility to some extent. Further, the belt member 11 incorporates at least a polyimide resin containing a fluorine atom in the molecular structure and may incorporate another resin material and additives if appropriate. Still further, on the surface making contact with the toner layer, a surface layer can be additionally laminated. In the present invention, however, those formed of only a polyimide resin containing a fluorine atom in the molecular structure are preferable.

Further, the thickness of a belt member 11 is not specifically limited, being, however, preferably, for example, 10 μm-200 μm from the viewpoint of exhibiting moderate mechanical strength and flexibility, more preferably 50 μm-100 μm in terms of thermal conductivity and conveyance performance. In this manner, the thickness of the belt member 11 is allowed to fall in the above range, and thereby mechanical strength required for use as a belt member for a glossy surface forming apparatus and flexibility realizing uniform contact with a toner on an image support are expressed. Still further, there is expressed excellent thermal conductivity to quickly heat a toner having been fed on an image support within a given duration and to quickly cool and solidify a melted toner within a given duration. Especially, a toner having been fed over the entire image support can be heated and then cooled uniformly without irregularity to certainly form a glossy surface exhibiting enhanced glossiness and uniformity without irregularity over the entire image support.

Next, the “center line average roughness” of a belt member 11 will be described. As described above, the center line average roughness Ra of a belt member 11 used in the present invention is allowed to be at most 03 μm, and thereby a glossy surface exhibiting enhanced glossiness can be formed. In other words, in determination of glossiness, for example, when the measurement angle is set at 20° to carry out measurement based on “JIS Z8741 1983 method 2,” a glossy surface of a glossiness of at least 70 can be formed.

Herein, “center line average roughness” is one of the methods to numerically specify the surface state of a belt member 11, being specified by a value in which a roughness curve is folded at the center line and then an area obtained from the roughness curve and the center line is divided by measured length. The center line average roughness is specified by JIS B 0601 and expressed in micrometers (μm).

FIG. 2 is a chart illustrating center line average roughness Ra. In this chart, the curve represented by f(x) is a roughness curve. Straight line C passing through roughness curve f(x) is a center line and L shown by an arrow is a measured length. Then, the center line average roughness is represented by Ra. Center line average roughness Ra can be represented as described below using roughness curve f(x) and measured length L

$$Ra = \frac{1}{L} {\int }_{0}^{L} \vert f ( x ) \vert d x$$

A specific measurement method of center line average roughness Ra includes, for example, a stylus method and an optical method. As the stylus-type surface measurement instrument, available are commercially available products such as, for example, “SURFTEST SJ-301” (produced by Mitutoyo Corp.). Further, a surface measurement instrument employing an optical method includes commercially available laser microscopes such as “VK-9700” (produced by Keyence Corp.) and “LEXT OLS4000” (produced by Olympus Corp.) enabling to carry out non-contact surface shape measurement.

As described above, in the present invention, the center line average roughness Ra of a surface layer 112 is allowed to be at most 0.3 μm, and thereby a glossy surface having a glossiness of at least 70 at a measurement angle of 20° can be formed. Thus, a center line average roughness Ra of 0.05 μm-0.1 μm makes it possible to form a glossy surface of a glossiness of at least 80.

Next, a glossy surface forming apparatus to form a glossy surface on an image support on which a toner has been fed will be described. FIG. 3 is a schematic view of a glossy surface forming apparatus in which a toner having been fed on an image support is heated and melted, and a melted toner is cooled to form a glossy surface on the image support. The glossy surface forming apparatus shown in FIG. 3 can form a glossy surface over the entire image support with respect to an image support in the state where toners have been fed over the entire image support in a layered manner.

Namely, the glossy surface forming apparatus shown in FIG. 3 is equivalent to the glossy surface forming apparatus, referred to in the present invention, provided with at least a heating member to heat an image support on which a toner has been fed, a belt member with which the image support is brought into close contact via the toner having been melted via heating by the heating member, a cooling member to convey the image support in the state of being in close contact with the belt member to cool the toner, and a separating member to separate the image support on which the toner has been solidified via cooling by the cooling member from the belt member.

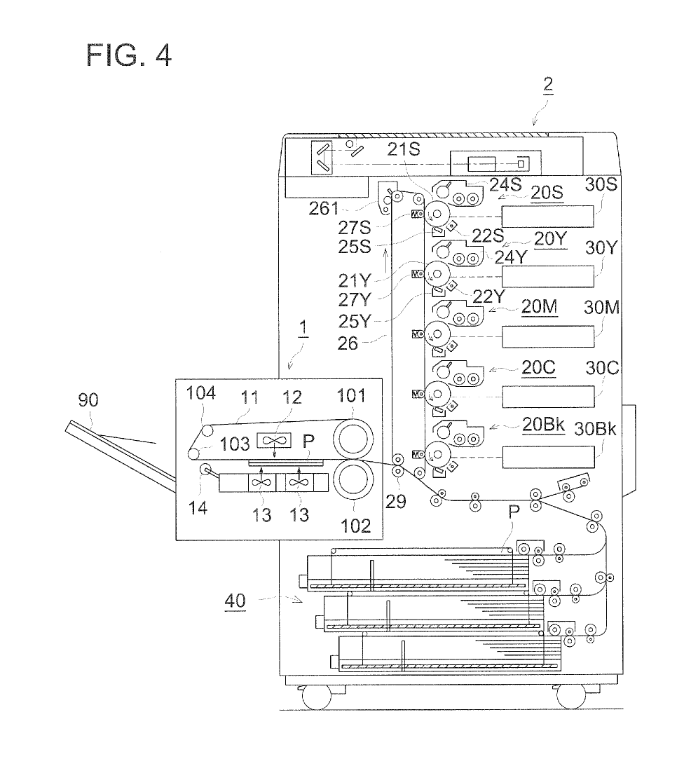

In formation of a toner layer on an image support, initially, a toner having been fed over the entire image support on a side having been subjected to image formation using an image forming apparatus such as a printer is passed through a nip section formed by the heating roll and the pressure roll for heating and melting. Subsequently, via a melted toner, the image support is brought into close contact with the belt member and then in this state, while the image support is conveyed, the toner is cooled and hardened. After a tone layer having been formed over the entire image support has been hardened, the image support is separated from the belt member. In this manner, the glossy surface forming apparatus of FIG. 3 can produce a printed material having a uniform glossy surface over the entire image support. Herein, the glossy surface forming apparatus of FIG. 3 can be used by being mounted in or connected to an image forming apparatus such as a printer or a printing apparatus, as shown in FIG. 4 to be described later.

The glossy surface forming apparatus 1 shown in FIG. 3 has at least the following constitution:

(1) a heating and pressing device 10 to heat and at the same time, press an image support P having a toner over the entire image support and a belt member at a nip section formed by rolls 101 and 102, in which the belt member makes contact with a surface having the toner of the image support;

(2) a belt member 11 to make contact with a toner having been melted by the heating and pressing device 10 to allow the toner to make close contact with the image support P and then to convey the image support P in the state of being in close contact;

(3) cooling fans 12 and 13 to supply cooing air to the image support P which is being conveyed in the state of adhering to the belt member 11;

(4) a separation roll 103 and a driven roll 104 to stretch the belt member 11 together with the roll 101 constituting the above heating and pressing device to change the conveyance direction of the belt member 11 having come to be conveyed via the rotational force of the roll 101; and

(5) a conveyance auxiliary roll 14 to aid the conveyance of the image support on which the toner has been solidified by cooling via the action of air supplied from the cooling fans 12 and 13.

Herein, the roll 101 constituting the heating and pressing device 10 of the glossy surface forming apparatus 1 of FIG. 3 is rotated by a drive member, not shown, and then the belt member 11 is driven by the rotational force of the roll 101. The conveyance direction of the belt member 11 is changed by the separation roll 103 and the driven roll 104, and by this change of the conveyance direction, the image support being in close contact with the belt member 11 is separated from the belt member 11 to be conveyed in the arrow direction with the aid of the conveyance auxiliary roll 14. Further, in FIG. 3, the surface in which the belt member 11 makes contact with a toner layer is shown as symbol 11S.

Each constitution will now specifically be described. Herein, the belt member 11 is as described above.

Initially, the heating and pressing device 10 will be described. As shown in FIG. 3, the heating and pressing device 10 nips an image support P on which a toner has been fed at a pressure contact section (nip section) formed by a pair of rolls 101 and 102 driven at constant velocity for conveyance to heat and press the thus-conveyed image support. Namely, the heating and pressing device 10 corresponds to a heating member, referred to in the present invention, to heat an image support on which a toner has been fed. In the heating and pressure roll 10, a toner having been previously fed on an image support P is melted by heating and at the same time, the thus-melted toner is formed into a layer having uniform thickness via pressing. Herein, when at the central portion of one or both of the paired rolls 101 and 102, a heat source is provided, a toner having been fed over the entire image support can be heated to be melted. Further, the two rolls 101 and 102 preferably create a pressure contact structure so as to certainly press a toner having been melted between the mils.

In the glossy surface forming apparatus 1 of FIG. 3, from the viewpoint of power consumption amount and operation efficiency, when, for example, the roll 101 and the roll 102 constituting the heating and pressing device 10 are allowed to serve as a heating roll and a pressure roll, respectively, adequate heating and pressing are carried out. On the surface of one or both of the rolls 101 and 102, a silicone rubber layer or a fluorine rubber layer can be arranged. The width of the nip region for heating and pressing is preferably about 1 mm-8 mm.

The heating roll 101 is formed with a predetermined outer diameter in such a manner that, for example, the base body surface made of a metal such as aluminum is covered with an elastic body layer formed of silicone rubber. In the interior of the heating roll 101, for example, a halogen lamp of 300-350 W is arranged as a heating source to carry out heating from the interior so that the surface temperature of the heating roll 101 reaches a predetermined temperature.

The pressure roil 102 is formed with a predetermined outer diameter in such a manner that, for example, the base body surface made of a metal such as aluminum is covered with an elastic body layer made of silicone rubber and further the resulting elastic body layer surface is covered with a releasing layer made with a tube of a PFA (tetrafluoroethylene-perfluoroalkyl vinyl ether copolymer). Also in the interior of the pressure roll 102, for example, a halogen lamp of 300-350 W can be arranged as a heating source to carry out heating from the interior so that the surface temperature of the pressure roll 101 reaches a predetermined temperature.

An image support P in which a toner has been fed over the entire image forming surface is conveyed to the pressure contact section (nip section) formed by the heating roll 101 and the pressure roll 102 of the heating and pressing device 10. In this case, conveyance is carried out so that the surface on which the toner has been fed is placed on the heating roll 101 side. Then, while being passed through the pressure contact section of the heating roll 101 and the pressure roll 102, the toner is heated and melted to be fused, at the same time, on the image surface as a toner layer.

Next, the cooling fans 12 and 13 will be described. The glossy surface forming apparatus 1 shown in FIG. 3 is provided with a cooling fan 12 between the heating mil 101 and the separation roll 103 on the inner surface side of the belt member 11 and a cooling roll 13 between the pressure roll 102 and the conveyance roll 14 on the outer surface side of the belt member 11. The cooling fans 12 and 13 cool a toner on an image support which is being conveyed in the state of being in close contact with the belt member 11. In other words, the cooling fans 12 and 13 correspond to the cooling member referred to in the present invention.

Incidentally, the surface of the belt member 11 with which an image support is brought into close contact via a melted toner to convey the image support in the state of being in close contact adheres to an image support P via a melted toner to hold and carry the image support P in the state where an adhesion surface has been formed.

In the glossy surface forming apparatus 1 of FIG. 3, an image support P is brought into close contact with the belt member 11 via a toner melted with a given thickness by the heating and pressing device 10, and in this state, while the image support P is conveyed, the toner layer is cooled and solidified by the cooling fans 12 and 13. The cooling fans 12 and 13 supply air to the image support P which is being conveyed in the state of adhering to the belt member 11 via the toner layer for forced cooling. Via forced cooling using the cooling fans 12 and 13, solidification of the toner layer of the image support P during being conveyed on the belt member 11 is allowed to progress. Further, in the glossy surface forming apparatus 1, a cooling heat sink or heat pipe connecting each to the cooling fans 12 and 13 can be arranged. Then, such a cooing heat sink or heat pipe accelerates cooling of a melted toner layer for rapid solidification.

Subsequently, the image support Pin which the toner layer has been solidified by the cooling fans 12 and 13 is separated from the belt member 11 surface at the belt end portion formed by arrangement of the separation roll 103. Namely, the separation roll 103 at least corresponds to the separation member, referred to in the present invention, to separate an image support in which a toner has been solidified from the belt member.

In the glossy surface forming apparatus 1 of FIG. 3, to separate the image support P in which the toner has been solidified from the belt member 11, the following procedures are conducted. Initially, the image support P in the state of being in close contact with the belt member 11 is conveyed to the vicinity of the belt end portion formed by the separation roll 103. At the belt end portion formed by the separation roll 103, a conveyance auxiliary roll 14 is arranged so as to be able to hold the image support P, which is being conveyed, from the rear side. Then, in this state, the conveyance direction of the belt member 11 is changed to the direction where the driven roll 104 is arranged (upward in the figure) to separate the image support P from the belt member 11. At the same time, the image support P is held by the conveyance auxiliary roll 14 to accelerate separation from the belt member 11.

In this manner, the separation roll 103 is arranged to change the conveyance direction of the belt member 11. The conveyance direction of the belt member 11 is changed and then a belt end portion is formed to separate the image support P from the belt member 11 at the belt member 11 end portion. Then, the image support P having been separated from the belt member 11 is conveyed in the arrow direction to be separated and discharged from the glossy surface forming apparatus 1.

Via the above procedures, the glossy surface forming apparatus 1 shown in FIG. 3 can form a toner layer having a glossy surface exhibiting uniformity without irregularity over the entire image support on a side where an image has been formed. Namely, the above procedures contain the following steps: (1) a toner having been fed over the entire image support is heated and melted; (2) via a melted toner, an image support P is brought into close contact with the belt member 11 and with conveyance in this state, the toner is cooled and solidified; (3) when the toner has been sufficiently solidified, the image support P is separated from the belt member 11; and (4) the image support P having been separated from the belt member 11 is discharged to the outside of the glossy surface forming apparatus.

In the present invention, an image support P is tightly held by the belt member 11 until the conveyance direction of the belt member 11 is changed by the separation roll 103 to realize stable conveyance. Then, at the belt member 11 end portion formed by changing the conveyance direction of the belt member 11 by the separation roll 103, the image support P is separated from the belt member 11. In this manner, the belt member 11 exhibits both stable conveyance performance to tightly hold an image support P and releasability to smoothly separate the image support P.

Herein, in the glossy surface forming apparatus shown in FIG. 3, an image support P is separated from the belt member 11 by the conveyance auxiliary roll 14 and the separation roll 103 but a separation member other than the separation roll 103 is employable. For example, it is possible that instead of the separation roll 103, a separation nail is arranged between the belt member 11 and the image support P to separate the image support P from the belt member 11.

Next, image supports usable in the present invention will be described. An image support on which a glossy surface is formed using the glossy surface forming apparatus shown in FIG. 3 mounted with a belt member 11 structured as shown in FIG. 1 is generally referred to as a transfer medium, which is a member to form and hold a toner layer on a visible image having been formed thereon. Image supports usable in the present invention include, for example, plain paper, being thin to thick, bond paper, art paper, and coated printing paper such as coated paper, as well as commercially available Japanese paper and postcard paper, OHP plastic films, and cloths.

As a typical example of a toner usable in the present invention, there is cited a toner referred to as a clear toner incorporating colorless, transparent resin particles containing no colorant (for example, a coloring pigment, a coloring dye, black carbon particles, or black magnetic powder) colored via the action of light absorption or light scattering. Further, the production method of a toner usable in the present invention is not specifically limited and any appropriate toner production method used for an electrophotographic image forming method is applicable. Namely, applicable is a toner production method via a so-called pulverization method in which a toner is produced via kneading, pulverization, and classification steps or a so-called polymerization method in which a polymerizable monomer is polymerized and simultaneously with control of the shape and size, particles are formed.

### Examples

The embodiment of the present invention will now specifically be described with reference to examples that by no means limit the scope of the present invention. Herein, “parts” in the following description represent “parts by mass.”

1. Production of “Belt Members 1-8”

1-1. Production of “Belt Members 1, 2, 4, 5, and 7”

(1) Production of “Polyimide Precursor 1”

Into a flask fitted with a stirrer, a nitrogen introducing tube, and a calcium chloride tube, 0.5 moles of 4,4′-diaminobiphenyl being an aromatic diamine compound and an appropriate amount of dimethylacetamide (DMAc) are added to be dissolved. Then, to the resulting solution, 0.5 mole of 1,4-di(trifluoromethyl)pyromellitic acid dianhydride being an aromatic carboxylic acid dianhydride is added for reaction together to produce “polyimide precursor 1” containing fluorine in the molecular structure.

(2) Production of “Belt Member 1”

Twenty parts by mass of “polyimide precursor 1” was dissolved in N-methylpyrrolidone at a solid content concentration of 10% by mass, and then the dissolved matter was poured into “molding die 1” having a diameter of 400 mm, a width of 320 mm, and a center line average roughness Ra of 0.05 μm. “Molding die 1” in which the dissolved matter had been poured was rotated at high speed to form a film, which was then heated at 300° C. for 4 hours to produce “belt member 1” via a centrifugal molding method.

The thickness of thus-produced “belt member 1” and the center line average roughness Ra of the surface making contact with the toner layer were measured and calculated. The thickness was measured using a commercially available micrometer. Further, with regard to the center line average roughness Ra of the surface making contact with the toner layer, using laser microscope “VK-9500” (produced by Keyence Corp.) fitted with a lens of a magnification of 50 times, the surface making contact with the toner layer of the belt member was photographed and then the center line average roughnesses of 3 points selected at random were calculated, whereby the average value thereof was designated as the center line average roughness Ra of “belt member 1.” The thickness of “belt member 1” measured and calculated in this manner was 50 μm and the center line average roughness Ra of the surface making contact with the toner layer was 0.05 μm.

(3) Production of “Belt Member 2”

“Belt member 2” was produced in the same manner as in production of “belt member 1” except that instead of “molding die 1” used in production of “bell member 1,” “molding die 2” having a diameter of 400 mm, a width of 320 mm, and a center line average roughness Ra of 030 μm was used. Using the above measurement method, the thickness of “belt member 2” and the center line average roughness Ra of the surface making contact with the toner layer were measured. Then, the thickness was 50 μm and the center line average roughness Ra was 0.30 μm.

(4) Production of “Belt Member 4”

“Belt member 4” was produced in the same manner as in production of “belt member 1” except that the amount of “polyimide precursor 1” to be poured into “molding die 1” was changed to 45 parts by mass. Using the above measurement method, the thickness of “belt member 4” and the center line average roughness Ra of the surface making contact with the toner layer were measured. Then, the thickness was 110 μm and the center line average roughness Ra was 0.05 μm.

(5) Production of “Belt Member 5”

“Belt member 5” was produced in the same manner as in production of “belt member 1” except that the amount of “polyimide precursor 1” to be poured into “molding die 1” was changed to 16 parts by mass. Using the above measurement method, the thickness of “belt member 5” and the center line average roughness Ra of the surface making contact with the toner layer were measured. Then, the thickness was 40 μm and the center line average roughness Ra was 0.05 μm.

(6) Production of “Belt Member 7”

“Belt member 7” was produced in the same manner as in production of “belt member 1” except that instead of “molding die 1” used in production of “bell member 1,” “molding die 3” having a diameter of 400 mm, a width of 320 mm, and a center line average roughness Ra of 0.50 μm was used. Using the above measurement method, the thickness of “belt member 7” and the center line average roughness Ra of the surface making contact with the toner layer were measured. Then, the thickness was 50 μm and the center line average roughness Ra was 0.50 μm.

1-2. Production of “Belt Members 3, 6, and 8”

(1) Production of “Polyimide Precursor 2”

In production of “polyimide precursor 1,” 4,4′-diamionbiphenyl being an aromatic diamine compound was replaced with 2,2′-bis(trifluoromethyl)-4,4′-diaminobiphenyl of 0.5 mole and 1,4-di(trifluoromethyl)pyromellitic acid dianhydride being an aromatic carboxylic acid dianhydride was replaced with pyromellitic acid dianhydride of 0.5 mole. In the same method other than the above replacements, “polyimide precursor 2” containing fluorine in the molecular structure was produced.

(2) Production of “Polyimide Precursor 3”

In production of “polyimide precursor 1,” 1,4-di(trifluoromethyl)pyromellitic acid dianhydride being an aromatic carboxylic acid dianhydride was replaced with pyromellitic acid dianhydride of 0.5 moles. In the same method other than the above replacement, “polyimide precursor 3” was produced.

(3) Production of “Belt Members 3 and 6”

“Belt member 3” was produced in the same manner as in production of “belt member 1” except that “polyimide precursor 1” to be poured into “molding die 1” was replaced with “polyimide precursor 2” containing fluorine in the molecular structure. Then, “belt member 6” was produced in the same manner as in production of “belt member 1” except that “polyimide precursor 1” to be poured into “molding die 1” was replaced with “polyimide precursor 3.” Using the above measurement method, the thickness of each of “belt members 3 and 6” and the center line average roughness Ra of the surface making contact with the toner layer were measured. Both belt members have a thickness of 50 μm and a center line average roughness Ra of 0.05 μm.

(4) Production of “Belt Member 8”

As “belt member 8,” there was prepared a thermally fixed film as disclosed in above Patent Document 2 (Unexamined Japanese Patent Application Publication No. 10-111613) in which on a polyimide film base layer, a rubber elastic body intermediate layer and a releasable surface layer were provided in this order. “Belt member 8” was produced based on the following procedures. Initially, a polyimide precursor solution of a viscosity of 150 Pa·s obtained in such a manner that a commercially available polyimide precursor was dissolved in dimethylacetamide/naphtha (9/1) was subjected to die coating on the surface of an aluminum core body having an outer diameter of 30 mm and a length of 400 mm. Then, the core body on which the polyimide precursor solution had been coated was heated at 250° C. for 25 minutes to produce a polyimide base layer of a thickness of 50 μm. Herein, as the commercially available polyimide precursor, U VARNISH S (a trade name) (produced by Ube Industries, ltd.) was used.

Subsequently, on the polyimide base layer, LTV silicone rubber of Hs20° (trade name: XE15-751 (produced by Toshiba Silicones Co., Ltd.)) was subjected to die coating, followed by heating at 120° C. for 20 minutes to provide a rubber elastic layer of a thickness of 50 μm. Then, on the rubber elastic layer surface, an FEP dispersion (trade name: ND-1 (produced by Daikin Industries, Ltd.)) was spray-coated as a fluorine resin, followed by heating at 300° C. for 30 minutes to form a releasable surface layer of a thickness of 10 μm.

The numbers of the polyimide precursors used to produce “belt members 1-8” having been produced by the above procedures, the names and the added amounts of the aromatic carboxylic acid dianhydrides and the aromatic diamines, and the thicknesses and the center line average roughnesses Ra of the formed belt members are shown in Table 1 below.

TABLE 1

| | | | | | Precursor | Belt Member | |
|---|---|---|---|---|---|---|---|
| Belt | Polyimide Precursor Conditions | | | | Addition | Physical Value | |
| Member | Precursor | | | Molding | Amount | Thickness | Ra |
| No. | No. | Carboxylic Acid Dianhydride | Diamine | Die No. | (parts by mass) | (μm) | (μm) |
| 1 | 1 | 1,4-di(trifluoromethyl)pyromellitic acid | 4,4′-diaminobiphenyl | 1 | 20 | 50 | 0.05 |
| | | dianhydride | | | | | |
| 2 | 1 | 1,4-di(trifluoromethyl)pyromellitic acid | 4,4′-diaminobiphenyl | 2 | 20 | 50 | 0.30 |
| | | dianhydride | | | | | |
| 3 | 2 | pyromellitic acid dianhydride | 2,2′-bis(trifluoromethyl)- | 1 | 20 | 50 | 0.05 |
| | | | 4,4′-diaminobiphenyl | | | | |
| 4 | 1 | 1,4-di(trifluoromethyl)pyromellitic acid | 4,4′-diaminobiphenyl | 1 | 45 | 110 | 0.05 |
| | | dianhydride | | | | | |
| 5 | 1 | 1,4-di(trifluoromethyl)pyromellitic acid | 4,4′-diaminobiphenyl | 1 | 16 | 40 | 0.05 |
| | | dianhydride | | | | | |
| 6 | 3 | pyromellitic acid dianhydride | 4,4′-diaminobiphenyl | 1 | 20 | 50 | 0.05 |
| 7 | 1 | 1,4-di(trifluoromethyl)pyromellitic acid | 4,4′-diaminobiphenyl | 3 | 20 | 50 | 0.50 |
| | | dianhydride | | | | | |
| 8 | — | — | — | — | — | 110 | — |

2. Production of “Clear Toner 1” and “Clear Toner Developer 1”

Via a production process of resin fine particles by a multistage polymerization method and a coagulation/fusion process by an emulsifying association method, “clear toner 1” was produced.

2-1. Production of “Resin Fine Particle 3”

As described below, via 3-stage polymerization reaction, namely, by a multistage polymerization method, “resin fine particle 3” was produced.

(1) First-Stage Polymerization

Into a reaction container fitted with a stirrer, a temperature sensor, a condenser tube, and a nitrogen introducing device, 4 parts by mass of sodium polyoxyethylene(2) dodecyl ether sulfate and 3000 parts by mass of ion exchange water were placed, and then the inner temperature was raised up to 80° C. with stirring at a stirring rate of 230 rpm under nitrogen stream.

After temperature elevation, an initiator solution, in which 5 parts by mass of potassium persulfate (KPS) was dissolved in 200 parts by mass of ion exchange water, was added to the resulting solution. Thereafter, the liquid temperature was raised up to 75° C. and then a monomer mixed liquid containing the following compounds was dripped over 1 hour. After chipping, heating/stirring was carried out at 75° C. for 2 hours for polymerization reaction to produce a dispersion liquid of “resin fine particle 1.” The weight average molecular weight of “resin fine particle 1” was determined to be 60,000 using gel permeation chromatography.

Herein, the monomer mixed liquid contains the following compounds.

| | |
|---|---|
| Styrene | 567 parts by mass |
| n-Butyl acrylate | 165 parts by mass |
| Methacrylic acid | 68 parts by mass |

(2) Second-Stage Polymerization

Subsequently, into a reaction container fitted with a stirrer, a temperature sensor, a condenser tube, and a nitrogen introducing device, 2 parts by mass of sodium polyoxyethylene(2) dodecyl ether sulfate and 1270 parts by mass of ion exchange water were placed, and then the inner temperature was raised up to 80° C. After heating, 40 parts by mass of “resin fine particle 1” in terms of the solid content and a monomer mixed liquid containing the following compounds were added. Then, using a mechanical homogenizer equipped with a circulation path, “CLEAR MK (produced by M Technique Co., Ltd.), mixing/dispersion treatment was carried out for 1 hour to prepare an emulsified particle dispersion liquid.

Herein, the monomer mixed liquid contains the following compounds, in which WEP-5 was allowed to be dissolved by heating at 80° C.

| | |
|---|---|
| Styrene | 123 parts by mass |
| n-Butyl acrylate | 45 parts by mass |
| Methacrylic acid | 20 parts by mass |
| n-Octylmercaptan | 0.5 parts by mass |
| WEP-5 | 82 parts by mass |

Subsequently, an initiator solution, in which 5 parts by mass of potassium persulfate (KPS) was dissolved in 100 parts by mass of ion exchange water, was added into the emulsified particle dispersion liquid. Thereafter, this system was heated and stirred at 80° C. for 1 hour for polymerization reaction to produce a dispersion liquid of “resin fine particle 2.”

(3) Third-Stage Polymerization

Subsequently, an initiator solution, in which 10 parts by mass of potassium persulfate (KPS) was dissolved in 200 parts by mass of ion exchange water, was added into the dispersion liquid of “resin the particle 2.” Then, the liquid temperature was raised up to 80° C. and then a monomer mixed liquid containing the following compounds was dripped over 1 hour.

Herein, the monomer mixed liquid contains the following compounds.

| | |
|---|---|
| Styrene | 390 parts by mass |
| n-Butyl acrylate | 143 parts by mass |
| Methacrylic acid | 37 parts by mass |
| n-Octylmercaptan | 13 parts by mass |

After dripping of the monomer mixed liquid, heating/stirring was carried out at 80° C. for 2 hours for polymerization reaction, followed by cooling down to 28° C. to produce “resin fine particle 3.”

2-2. Production of “Clear Toner 1”

(1) Coagulation/Fusion Step

A reaction container fitted with a stirrer, a temperature sensor, a condenser tube, and a nitrogen introducing device was charged with the following materials to be stirred.

| | |
|---|---|
| “Resin fine particle 3” | 450 parts by mass |
| | (in terms of the solid content) |
| Ion exchange water | 1100 parts by mass |
| Sodium dodecyl sulfate | 2 parts by mass |

The temperature inside the reaction container was adjusted at 30° C., followed by addition of 5 mole/1 of a sodium hydroxide aqueous solution to adjust the pH at 10.

Subsequently, an aqueous solution, in which 60 parts by mass of magnesium chloride.6 hydrate was dissolved in 60 parts by mass of ion exchange water, was added with stirring at 30° C. over 10 minutes, followed by being allowed to stand for 3 minutes to initiate temperature elevation. The system temperature was raised up to 85° C. over 60 minutes and then above “resin fine particle 3” continued to be coagulated/fused at a maintained temperature of 85° C. In this state, using “MULTISIZER 3 (produced by Beckman Coulter, Inc.),” particle diameter measurement of particles which were being formed was carried out. Then, when the volume based median diameter of the particles reached 6.7 μm, an aqueous solution, in which 200 parts by mass of sodium chloride was dissolved in 860 parts by mass of ion exchange water, was added to terminate coagulation.

After termination of coagulation, for ripening treatment, the liquid temperature was raised up to 95° C. and then heating/stirring was carried out for 8 hours for the advancement of fusion in coagulated “resin fine particle 3” to form “toner host particle A.” After termination of ripening treatment, the liquid temperature was decreased to 30° C. Then, using hydrochloric acid, the pH in the liquid was adjusted at 2 to terminate stirring.

(2) Washing/Drying Step

“Toner host particle A” having been produced via the above step was subjected to solid liquid separation using basket-type centrifuge “MARK III Model No. 60x40 (produced by Matsumoto Machine Mfg. Co., Ltd.)” to form a wet cake of “toner host particle A.” This wet cake was washed with ion exchange water of 45° C. using the basket-type centrifuge until the electric conductivity of the filtrate reached 5 μS/cm and then transferred to “FLASH JET DRYER (produced by Seishin Enterprise Ca, Ltd.).” Drying treatment was carried out until the water content reached 0.5% by mass to purify “toner parent particle 1.”

(3) External Additive Addition Step

The following external additives were added at the following amounts to 100 parts by mass of produced “toner bast particle 1,” and then using “HENSCHEL MIXER (produced by Mitsui Miike Engineering Co., Ltd.),” external addition treatment was carried out to produce “clear toner 1.”

| | |
|---|---|
| Silica treated with hexamethylsilazane (average | 1.0 parts by mass |
| primary particle diameter: 12 nm, hydrophobization | |
| degree: 68) | |
| Titanium dioxide treated with n-octylsilane (average | 0.3 parts by mass |
| primary particle diameter: 20 nm, hydrophobization | |
| degree: 63) | |

Herein, the above external addition treatment using the HENSCHEL MIXER was carried out under conditions of a stirring vane peripheral velocity of 35 m/second, a treatment temperature of 35° C., and a treatment duration of 15 minutes.

Via the above procedures, “clear toner 1” was produced. The “clear toner 1” having been produced via the above procedures had a volume based median diameter of 6.7 μm, a softening point of 120° C. based on the above determination method, and 20% as the ratio of a molecular weight of at least 60,000.

2-3. Preparation of “Clear Toner Developer 1”

“Clear toner 1” was mixed with a ferrite carrier of a volume average particle diameter of 40 μm covered with a methyl methacrylate resin so as for the clear toner concentration to become 6% by mass to prepare “clear toner developer 1” formed as a two-component developer.

3. Evaluation Experiments

3-1. Evaluation Conditions

The glossy surface forming apparatus 1 having the constitution shown in FIG. 3 was mounted with each of “belt members 1-8” and also above “clear toner developer 1” was fed to the clear toner layer forming section 20S of the image forming apparatus 2 shown in FIG. 4 incorporating the glossy surface forming apparatus 1. Further, commercially available color toners applicable to the image forming apparatus were fed to the toner image forming sections 20Y-20Bk of the image forming apparatus. Herein, the image forming apparatus 2 of FIG. 4 incorporates the glossy surface forming apparatus 1 shown in FIG. 3. Specifically, commercially available electrophotographic image forming apparatus “bizhub C353 (produced by Konica Minolta Business Technologies, Inc.) was converted.

Evaluation was conducted by continuous printing of 1500 sheets in which as an image support, commercially available “OK TOPCOAT+ (basis weight 157 g/m², sheet thickness: 131 μm, A4 size) (produced by Oji Paper Co., Ltd.) was used and as an output image, “Test Chart No. 7” by the Imaging Society of Japan was used. Herein, in cases in which a glossy surface formed using “clear toner developer 1” was evaluated, a sample in which a toner image had been previously output on an image support was prepared. Then, only the clear toner layer forming section 20S was operated and above “clear toner developer 1” was fed over the entire image support to form a glossy surface. Further, when a glossy surface formed using color toners was evaluated, the toner image forming sections 20Y-20Bk were operated and the clear toner layer forming section 20S was not operated to form a color toner image. Then, the glossiness on the toner image was evaluated.

Herein, samples in which glossy surfaces formed using “belt members 1-5” and “clear toner developer 1” were evaluated were designated as “example 1-5,” and a sample in which a glossy surface formed using “belt member 1” and commercially available color toners was evaluated was designated as “example 6.” Further, samples in which glossy surfaces formed using “belt members 6-8” and “clear toner developer 1” were evaluated were designated as “comparative examples 1-3.”

Incidentally, in evaluation, the glossy surface forming apparatus 1 of FIG. 2 was set to the following specifications.

(a) Clear toner development amount 4 g/m²

(b) Specifications of the heating and pressure rolls

Heating roll: aluminum base body of an outer diameter 100 mm and a thickness of 10 mm

Pressure roll: A silicone rubber layer of a thickness of 3 mm was arranged on an aluminum base body of an outer diameter of 80 mm and a thickness of 10 mm.

A halogen lamp was arranged in the interior of the heating roll and the pressure roll each and the surface temperatures of the heating roll and the pressure roll were set 155° C. and 115° C., respectively (temperature-controlled by a thermistor).

Nip width of the heating roll and the pressure roll: 11 mm

(c) Transfer member temperature at the separation roll position: set at 50° C.

(d) Distance from the heating/pressure roll nip section to the separation roll position: 620 mm

(e) Image support conveyance velocity: 220 mm/second

(f) Image support conveyance direction: transverse conveyance of the image support of A4 size

(g) Evaluation ambience: normal temperature/humidity ambience (temperature: 20° C., relative humidity: 50% RH)

3-2. Evaluation Item

<Determination of Glossiness>

“Glossiness” referred to in the present invention refers to a value in which a glossy surface formed using a clear toner and the like under predetermined conditions is irradiated with light and then the magnitude of reflection of an obtained image support surface (glossy surface) is quantified. Herein, a glossy surface formed on an image support produced using the image forming apparatus mounted with each of above “belt members 1-8” was measured using commercially available gloss meter “GMX-203 (produced by Murakami Color Research Laboratory Co., Ltd.)” and evaluated.

Specifically, evaluation was carried out at a measurement angle of 20° based on “HS 28741 1983 method 2.”

In glossiness measurement, printed materials produced as the first sheet and the 1500th sheet in continuous printing were used. Then, those having a glossiness of at least 70 in each sheet and also a glossiness difference of less than 10 in both were evaluated to be acceptable, and those having a glossiness difference of at least 10 in both were evaluated to be unacceptable. Herein, glossiness was calculated as the average value of the values in 5 points containing the center and the 4 corners of a printed material.

The above results are shown in Table 2 below.

TABLE 2

| | | Center Line | | | |
|---|---|---|---|---|---|
| | Belt | Average | 20° Glossiness | | |
| | Member | Roughness | First | 1500th | |
| | No. | Ra (μm) | Sheet | Sheet | Difference |
| Example 1 | 1 | 0.05 | 83 | 80 | 3 |
| Example 2 | 2 | 0.30 | 75 | 71 | 4 |
| Example 3 | 3 | 0.05 | 84 | 79 | 5 |
| Example 4 | 4 | 0.05 | 82 | 76 | 6 |
| Example 5 | 5 | 0.05 | 83 | 79 | 4 |
| Example 6 | 1 | 0.05 | 83 | 77 | 6 |
| Comparative | 6 | 0.05 | 79 | 61 | 18 |
| Example 1 | | | | | |
| Comparative | 7 | 0.50 | 60 | 55 | 5 |
| Example 2 | | | | | |
| Comparative | 8 | — | 70 | 52 | 18 |
| Example 3 | | | | | |

Table 2 confirmed that in each of “examples 1-6” satisfying the constitutional requirements specified in the present invention, the glossiness of a printed material each as the first sheet and the 1500th sheet was at least 70 and the difference in both was less than 10; and in contrast, in “comparative examples 1-3” having no constitutional requirements of the present invention, among printed materials as the first sheet and the 1500th sheet, those having a glossiness of less than 70 or a difference of at least 10 existed and thereby exhibited poor performance compared with “examples 1-6.”

1. A glossy surface forming apparatus comprising
a heating member to heat an image support on which a toner has been supplied,
a belt member with which the image support is brought into close contact via the toner having been melted via heating by the heating member to convey the image support in a state of being in close contact,
a cooling member to cool the toner on the image support which is being conveyed in a state of being in close contact with the belt member, and
a separating member to separate the image support on which the toner has been solidified via cooling by the cooling member from the belt member,
wherein the belt member contains at least a polyimide resin having a fluorine atom in the molecular structure and has a center line average roughness Ra of a surface making contact with a toner layer of at most 0.3 μm.

2. A glossy surface forming apparatus of claim 1, wherein the separating member separates the image support from the belt member at the position to change the conveyance direction of the belt member.

3. A glossy surface forming apparatus of claim 1, wherein the toner is a clear toner.

4. A glossy surface forming method comprising steps of
supplying a toner onto an image support,
bringing a side having the toner of the image support into close contact with a belt member,
heating and pressing the image support making close contact with a belt member to melt the toner,
cooling the image support having the toner having been melted in the above step in a state of being in close contact with the belt member, and
separating the image support on which the toner has been solidified by cooling from the belt member,
wherein the belt member contains at least a polyimide resin having a fluorine atom in a molecular structure and has a center line average roughness Ra of a surface making contact with a toner layer of at most 03 μm.

5. The glossy surface forming method of claim 4, wherein separating the image support on which the toner has been solidified by cooling from the belt member is conducted at the position to change the conveyance direction of the belt member, the image support is separated from the belt member.

6. The glossy surface forming method of claim 4, wherein the toner is a clear toner.

7. The glossy surface forming method of claim 4, wherein a thickness of the belt member is 10 μm-200 μm.

8. The glossy surface forming method of claim 7, wherein a thickness of the belt member is 50 μm-100 μm.

9. The glossy surface forming method of claim 4, wherein the belt member has a center line average roughness Ra of 0.05 μm-0.1 μm.
